(19) United States
(12) Patent Application Publication
(10) Pub. No.: US 2008/0112740 A1
(43) Pub. Date: May 15, 2008

(54) FUSING UNIT AND IMAGE FORMING APPARATUS USING THE SAME

(76) Inventor: Jeonghwa KIM, Suwon-si (KR)

Correspondence Address: STEIN, MCEWEN & BUI, LLP, 1400 EYE STREET, NW, SUITE 300, WASHINGTON, DC, 20005, US

(21) Appl. No.: 11/776,195

(22) Filed: Jul. 11, 2007

(30) Foreign Application Priority Data
Nov. 7, 2006 (KR) 2006-109407

(51) Int. Cl. G03G 15/20

(52) U.S. Cl. 399/333

(57) ABSTRACT

A fusing unit which is provided on a printing path, and which fuses an image onto a printing medium, includes: a heating roller having a core member, a rubber layer which is formed to have a predetermined thickness on an outer circumference of the core member, a release layer which is formed on the outer surface of the rubber layer and prevents the printing medium from being adhered to the heating roller during a fusing process, and a heating coil which is embedded inside the rubber layer and applies heat to the rubber layer; a pressing roller which is disposed to face the heating roller, and presses the printing medium in collaboration with the heating roller; and an elastic member which elastically biases the pressing roller toward the heating roller and forms a fusing nip to have a predetermined width between the heating roller and the pressing roller.

### CROSS-REFERENCE TO RELATED APPLICATION

This application claims priority from Korean Patent Application No. 2006-109407, filed on Nov. 7, 2006 in the Korean Intellectual Property Office, the disclosure of which is incorporated herein by reference.

### BACKGROUND OF THE INVENTION

1. Field of the Invention

An aspect of the present invention relates to a fusing unit which heats and fuses a non-fused image transferred on a printing medium and an image forming apparatus using the same, and more particularly, to a fusing unit which can prevent a wrap jam, secure the amount of heat necessary for fusing and minimize resistance loss around a heat source during a speed-up printing process, and an image forming apparatus using the same.

2. Description of the Related Art

In general, an electrophotographic image forming apparatus scans a beam onto a photosensitive medium electrified to a predetermined electric potential to form an electrostatic latent image, and develops the image with predetermined color toner and transfers and fuses the image onto a printing paper to print an image thereon. The electrophotographic image forming apparatus includes a fusing unit on a printing path so as to fuse the transferred image onto the printing medium.

FIG. 1 is a schematic sectional view illustrating a conventional lamp typed fusing unit. As shown in FIG. 1, the conventional fusing unit fuses a non-fused toner image T formed on the printing medium M. The fusing unit includes a heating roller 3 in which a lamp 1 is built, a pressing roller 5 which faces the heating roller 3 and is elastically biased toward the heating roller 3 by an elastic member 7 and forms a fusing nip (N), and a temperature sensor 9.

The heating roller 3 includes a first core pipe 3a provided as a metal material and a first elastic layer 3b provided on its surface layer. Accordingly, a radiant energy generated by the lamp 1 is converted into heat energy in a light-heat converting layer (not shown) provided on an interior surface layer of the first core pipe 3a, and accordingly, the first core pipe 3a is heated. Also, the first elastic layer 3b is heated by thermal conduction to rise to a predetermined fusing temperature and is maintained at that temperature.

The temperature sensor 9 either contacts or not the heating roller 3, and measures a surface temperature of the first elastic layer 3b. Accordingly, power supplied for the lamp 1 can be controlled on the basis of the surface temperature value measured in the temperature sensor 9.

The pressing roller 5 includes a second core pipe 5a provided as a metal material, and a second elastic layer 5b provided on its surface. Here, since the second elastic layer 5b is provided as a member having a weaker elasticity than the first elastic layer 3b, the second elastic layer 5b is distorted if the pressing roller 5 and the heating roller 3 are contacting and pressing each other.

Accordingly, if the printing medium M on which the non-fused toner image T is formed is transferred to the fusing unit, the toner image T passes through the fusing nip N formed between the rotating heating roller 3 and the pressing roller 5, and the image is welded on the printing medium M by heat and pressure, thereby being fused.

Meanwhile, as described above, when the fusing nip N is formed, the printing medium M is affected by formation of the fusing nip N, and proceeds in a direction of an arrow A. That is, since the printing medium M is bent toward an image-formed surface, a wrap jam (a phenomenon where the image-formed surface rises and is adhered to the surface of the heating roller 3) is likely to happen when the fused printing medium M passes through the fusing nip N.

Furthermore, there is a need to extend an external diameter of the heating roller and the pressing roller which form the fusing unit, or the thickness of the first and the second elastic layer to satisfy a demand for a faster color electrophotograhpic image forming apparatus using the above-described fusing unit. Therefore, in order to satisfy the demand from a faster apparatus, the contact time between the printing medium and the fusing nip must be extended, which is achieved by extending the width of the fusing nip.

However, considering the size of the above-described image forming apparatus, there is a limit on how much the size of the exterior diameter of the heating roller and the pressing roller can be expanded, and there are also problems related to a warm-up which may slow down the apparatus and increase the cost of the product.

In addition, extending the thickness of the first and the second elastic layer to secure the contact time of the printing medium M in the fusing nip not only causes the warm-up to slow down, but also requires increasing the heating temperature of the thickened first core pipe.

### SUMMARY OF THE INVENTION

Accordingly, it is an aspect of the present invention to provide a fusing unit which can secure a fusing stability with respect to a printing medium transferred at a high speed without extending an exterior diameter of a heating roller, and can prevent a wrap jam and a curl of the printing medium in a fusing nip, and an image forming apparatus using the fusing unit.

The foregoing and/or other aspects of the present invention can be achieved by providing a fusing unit which is provided on a printing path, and fuses an image which is transferred on a printing medium, including: a heating roller having a core member, a rubber layer which is formed to have a predetermined thickness on an outer circumference of the core member, a release layer which is formed on the outer surface of the rubber layer and prevents the printing medium from being adhered to the heating roller during a fusing process, and heating coil which is embedded inside the rubber layer and applies heat to the rubber layer; a pressing roller which is disposed to face the heating roller, and presses the printing medium in collaboration with the heating roller; and an elastic member which elastically biases the pressing roller toward the heating roller and forms a fusing nip to have a predetermined width between the heating roller and the pressing roller.

According to an aspect of the invention, the heating coil is embedded as deep as 0.2 mm to 0.7 mm from a surface of the rubber layer.

According to an aspect of the invention, the rubber layer is provided to have at least 5 mm thickness.

According to an aspect of the invention, the fusing unit further includes an insulating layer which is positioned between the core member and the rubber layer, or is embedded inside the rubber layer, and blocks the heat generated in the heating coil from being transferred to the core member.

According to an aspect of the invention, the rubber layer includes a material having a larger elasticity than the pressing roller so as to form the fusing nip by bending of the rubber layer.

According to an aspect of the invention, the fusing unit further includes a heat source which is built in the pressing roller, and applies heat to the pressing roller.

According to an aspect of the invention, the rubber layer includes a material having a larger elasticity than the pressing roller so as to form the fusing nip by bending of the rubber layer.

According to an aspect of the invention, the fusing unit further includes a heat source which is built in the pressing roller, and applies heat to the pressing roller.

According to an aspect of the invention, the heating roller is rotated depending on rotation of the pressing roller.

According to an aspect of the invention, the fusing unit further includes a heat source which is built in the pressing roller, and applies heat to the pressing roller.

The foregoing and/or other aspects of the present invention can be achieved by providing an image forming apparatus, including: a photosensitive medium; a light scanning unit which scans beam onto the photosensitive medium and forms an electrostatic latent image; a transferring unit which transfers a toner image formed in the developing unit onto a printing medium; and a fusing unit which fuses a non-fused toner image which is transferred to the printing medium.

According to an aspect of the invention, the image forming apparatus further includes an insulating layer which is positioned between the core member and the rubber layer or is embedded inside the rubber layer, and blocks heat generated in the heating coil from being transferred toward the core member.

According to an aspect of the invention, the rubber layer includes a material having a larger elasticity than the pressing roller so as to form the fusing nip by bending of the rubber layer.

According to an aspect of the invention, the image forming apparatus further includes a heat source which is built in the pressing roller and applies heat to the pressing roller.

According to an aspect of the invention, the rubber layer includes a material having a larger elasticity than the pressing roller so as to form the fusing nip by bending of the rubber layer.

According to an aspect of the invention, the image forming apparatus further comprises a heat source which is built in the pressing roller and applies heat to the pressing roller.

According to an aspect of the invention, the heating roller is rotated depending on rotation of the pressing roller.

According to an aspect of the invention, the image forming apparatus further includes a heat source which is built in the pressing roller and applies heat to the pressing roller

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic sectional view illustrating a conventional fusing unit.

FIG. 2 is a schematic sectional view illustrating a fusing unit according to a first exemplary embodiment of the present invention.

FIG. 3 is a schematic sectional view illustrating a fusing unit according to a second exemplary embodiment of the present invention.

FIG. 4 is a schematic sectional view illustrating a fusing unit according to a third exemplary embodiment of the present invention.

FIGS. 5A and 5B are graphs illustrating a temperature change on surface of a heating roller according to elapse of time in a fusing unit according to a comparative example of the present invention and an exemplary embodiment respectively.

FIG. 6 is a schematic sectional view illustrating an image forming apparatus according to an exemplary embodiment of the present invention.

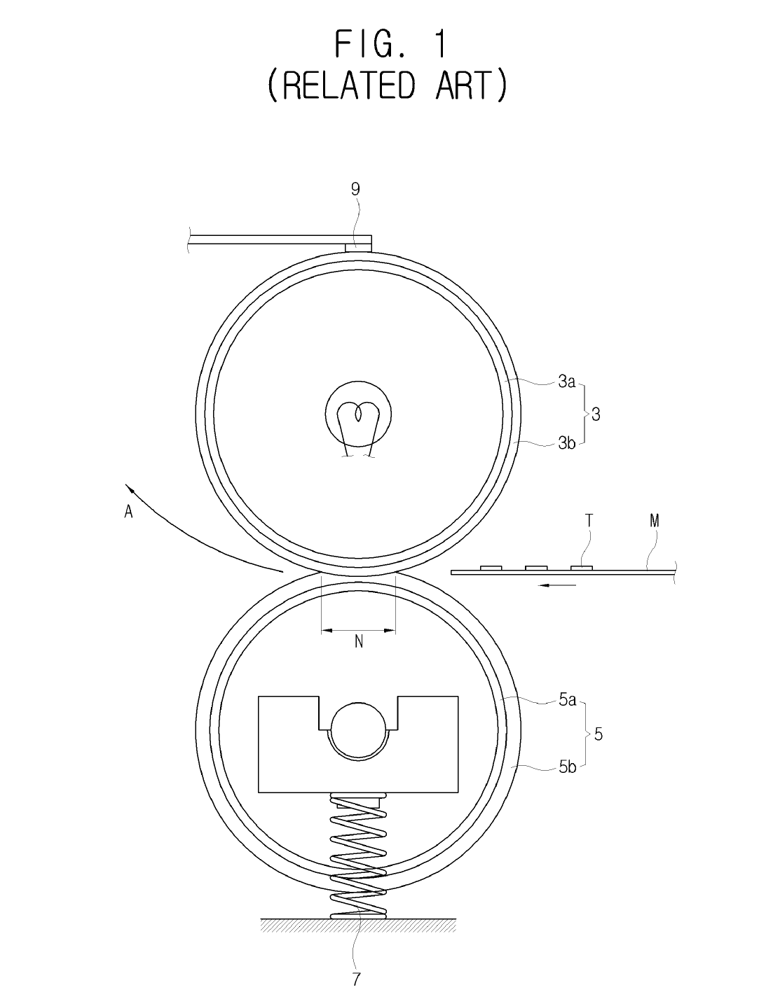

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

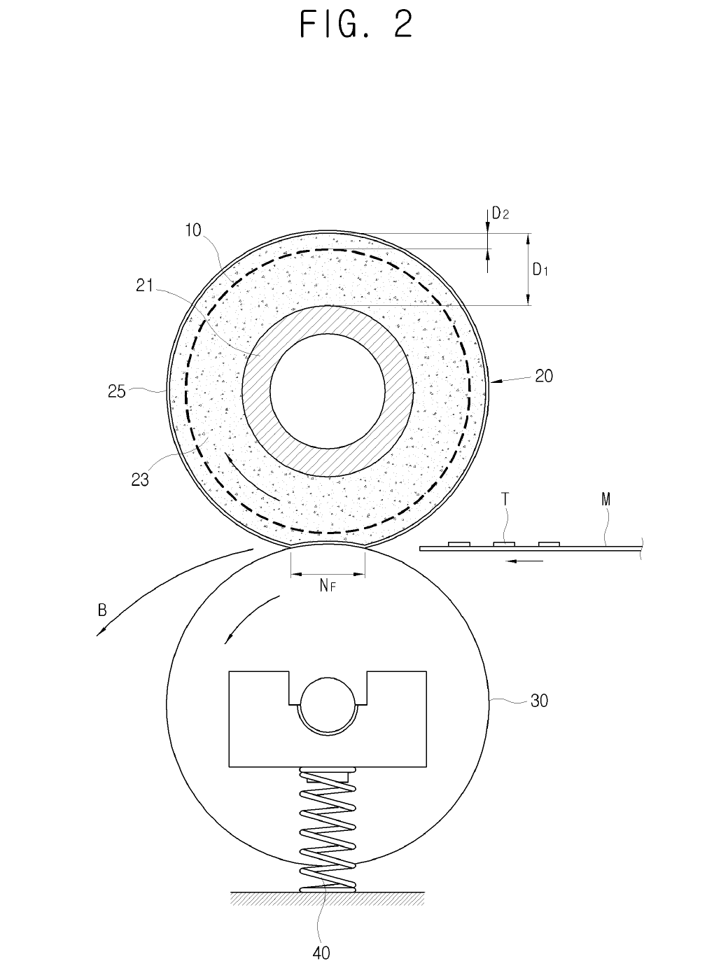

FIGS. 2 to 4 are schematic sectional views illustrating a fusing unit according to various exemplary embodiments of the present invention.

As shown in FIGS. 2 to 4, the fusing unit according to the exemplary embodiments is provided on a printing path of an image forming apparatus and fuses a non-fused toner image transferred onto a printing medium.

Referring to FIG. 2, the fusing unit according to a first exemplary embodiment of the present invention includes a heating roller 20, a pressing roller 30, and an elastic member 40 which elastically biases the pressing roller 30 toward the heating roller 20 and forms a predetermined width of a fusing nip N_{F} between the heating roller 20 and the pressing roller 30.

The heating roller 20 includes a core member 21, a rubber layer 23 which is formed to have a predetermined thickness on a circumference of the core member 21, a release layer 25 which is formed on an outer surface of the rubber layer 23 and prevents the printing medium M from being adhered to the heating roller 20 during a fusing process, and a heating coil 10 which is embedded in the rubber layer 23 and applies heat to the rubber 23.

The core member 21 includes aluminum (Al) alloy, or stainless alloy such as a metal STK. The core member 21 performs a role as a rotation supporting axis. That is, the core member 21 according to the exemplary embodiment of the present invention is not used as a heat transferring medium in comparison with the conventional core member.

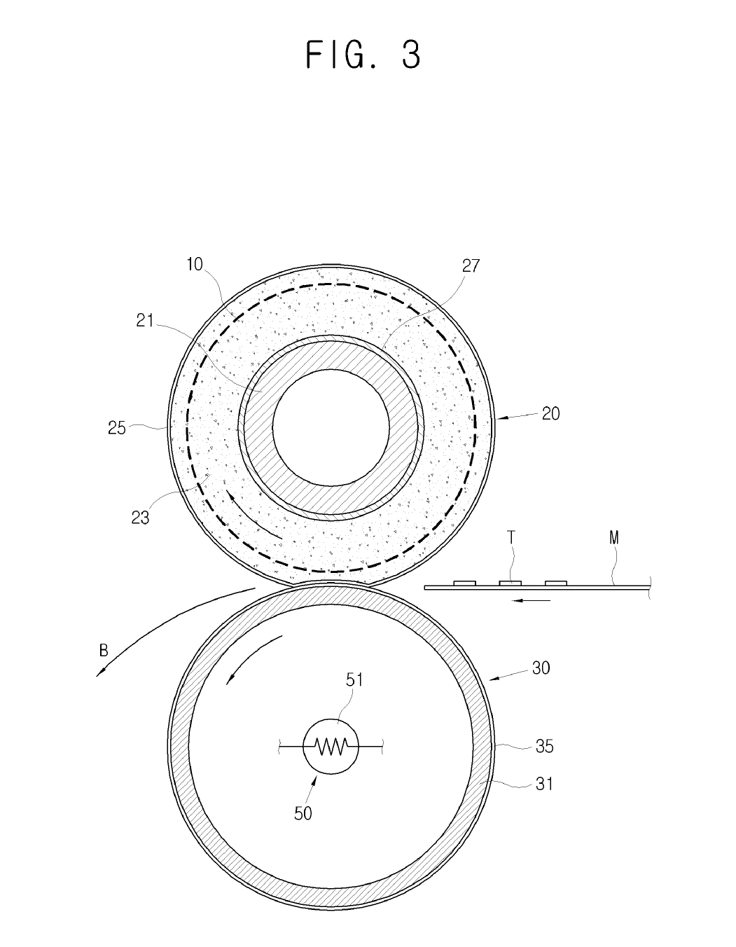

The rubber layer 23 is heated by the heating coil 10 embedded inside thereof, and fuses the non-fused toner image T onto the printing medium M by pressure caused by an interaction with the pressing roller 30, and its surface temperature. The elasticity of the rubber layer 23 is larger than the elasticity of the pressing roller 30. For this purpose, the pressing roller 30 includes a metal core (see 31 in FIG. 3) on the circumference of which a thin coating layer (see 35 in FIG. 3) having a predetermined elasticity is formed. Accordingly, if the pressing roller 30 is pressed toward the heating roller 20 by the elastic member 40, a pressed part of the rubber layer 23 is bent toward the core member 21, thereby forming the fusing nip N_{F}.

Also, the rubber layer 23 may be provided to have a thickness D₁ at least over 5 mm so as to secure enough width of the fusing nip N_{F} with small pressure.

The embedded heating coil 10 includes a resistance heating coil such as nicrome wire, and is embedding-filed inside the rubber layer 23 in an embedding method. Here, the description of the embedding method will be omitted as it is a known technology.

Also, the embedded heating coil 10 may be disposed closely to an outer surface of the rubber layer 23 so as to rapidly apply heat to the surface of the rubber layer 23 and enhance heat conduction efficiency. Also, if a filing depth from the outer surface of the rubber layer 23 of the embedded heating coil 10 is D₂, then D₂ may satisfy a following formula 1.

0.2 mm≦D₂≦0.7 mm Formula 1

The formula 1 is formed within a practically applicable range considering that a minimum thickness of the rubber layer 23 formed on the surface of the core member 21 is 0.7 mm, and the thickness of the rubber layer 23 can be provided as 0.2 mm if a heating belt (not shown) in place of the heating roller 20 is used in forming the heating roller 20. However, it is noted that these ranges are exemplary and the thickness of the core member can vary.

Also, as shown in FIG. 3, the heating roller 20 may further include an insulating layer 27 between the core member 21 and the rubber layer 23. The insulating layer 27 is provided as an insulating material such as mica having a strong thermal resistance or a polyimide. The insulating layer 27 blocks heat generated in the embedded heating coil 10 from being transferred toward the core member 21.

The insulating layer 27 is not restricted to a position in a border between the rubber layer 23 and the core member 21, but the insulating layer 27 can be embedded with the heating coil 10 inside the rubber layer 23.

As described above, the embedded heating coil 10 is disposed closely to the surface of the rubber layer 23, and the insulating layer 27 is further provided to block the generated heat from being transferred toward the core member 21, thereby enhancing heating efficiency.

As described above, the heating roller 20 is formed to conduct heat from the embedded heating coil 10 to the rubber layer 23 without a heat vehicle such as a conventional metal pipe, thereby enhancing heat transferring efficiency. Also, if the embedded heating coil 10 is located inside the rubber layer 23 as a heat source, the rubber layer 23 can be easily softened, thus forming the fusing nip N_{F}.

The pressing roller 30 is disposed to face the heating roller 20, and is elastically biased by the elastic member 40. Accordingly, a predetermined width of the fusing nip N_{F} is formed between the pressing roller 30 and the heating roller 20. As shown in FIGS. 2 and 3, the pressing roller 30 is rotationally driven counterclockwise if the printing medium M proceeds.

Also, the heating roller 20 is rotationally driven by the rotation of the pressing roller 30. Accordingly, a slip phenomenon in the fusing nip N_{F}, which can be generated when the heating roller 20 and the pressing roller 30 are respectively driven, can be eliminated, thereby preventing damage to the toner image T. Here, the description of the driving method of the heating roller 20 and the pressing roller 30 will be omitted as it is a known technology.

As shown in FIG. 3, the pressing roller 30 is provided with a metal core 31 which performs a role as a rotating axis, and a thin coating layer 35 having a predetermined elasticity formed along the circumference of the metal core 31. Accordingly, since the elasticity of the pressing roller 30 is smaller than the elasticity of the heating roller 20, the original shape of the pressing roller 30 can be maintained in the formation of the fusing nip N_{F}.

Therefore, by forming the fusing nip N_{F} having the shape shown in FIG. 3, the printing medium M passing through the heating roller 20 and the pressing roller 30 is bent in a direction of an arrow B which denotes the direction toward the pressing roller 30. Meanwhile, since the non-fused toner image T is positioned in the side of the heating roller 20, the toner image T does not adhere to the release layer 25 of the heating roller 20 and can be easily separated when passing through the fusing nip N_{F}. Accordingly, the wrap jam which is a phenomenon occurring when the printing medium M is wrapped onto the heating roller 20, or the curl which is a phenomenon occurring when the printing medium M is wrinkled can be lowered.

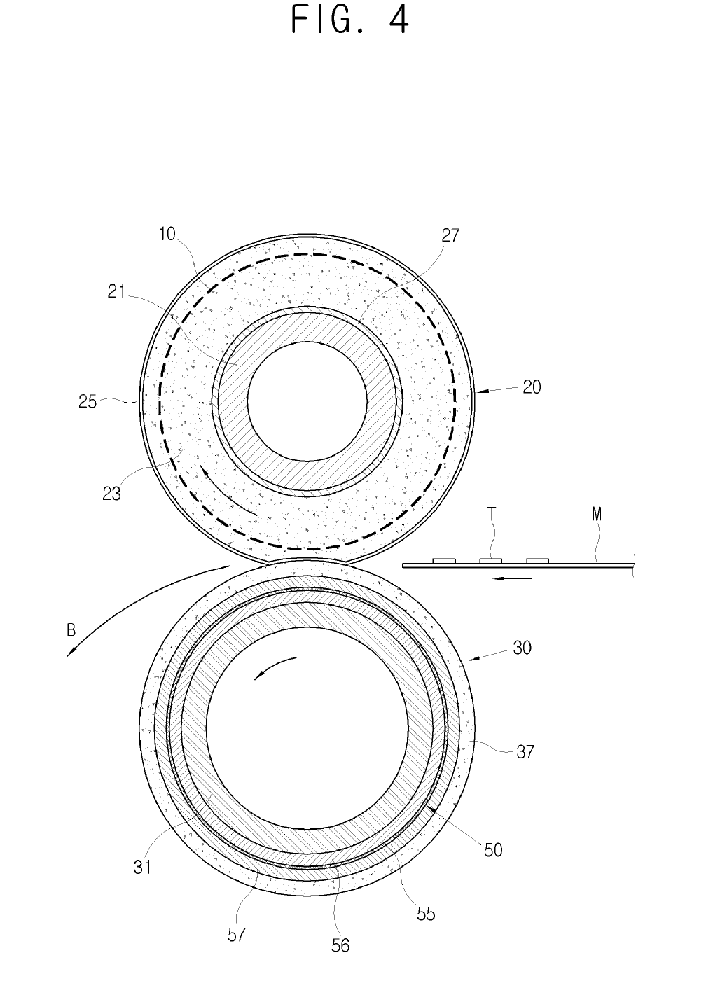

Also, as shown in FIGS. 3 and 4, the fusing unit according to the exemplary embodiments of the present invention may further include a heat source 50 which is located in the pressing roller 30 and applies heat to the pressing roller 30.

As shown in FIG. 3, the heat source 50 according to one of the exemplary embodiments of the present invention includes a lamp 51 which is provided in a hollow part of the metal core 31. The metal core 31 is heated by lighting from the lamp 51.

As shown in FIG. 4, the heat source 50 according to another one of the exemplary embodiments of the present invention includes a resistance heating unit 55 which is positioned inside the pressing roller 30 and applies heat to the pressing roller 30. The pressing roller 30 includes the metal core 31 and an elastic layer 37. The resistance heating unit 55 is formed between the metal core 31 and the elastic layer 37. The heat source 50 further includes a first insulating layer 56 positioned between the metal core 31 and the resistance heating unit 55, and a second insulating layer 57, positioned between the resistance heating unit 55 and the elastic layer 37, so as to electrically insulate the resistance heating unit 55 with the metal core 31 and the elastic layer 37.

As described above, by building the heat source 50 inside the pressing roller 30 and thereby supplying heat on both an image surface and the other surface of the printing medium M, a heat stress which is applied to the toner fused on the image surface can be offset. Accordingly, the printing medium M can be discharged from the apparatus without any printing media being rolled on any roller of the heating roller 20 and the pressing roller 30. Furthermore, it is noted that the printing media can be any one of a paper, a transparency, etc.

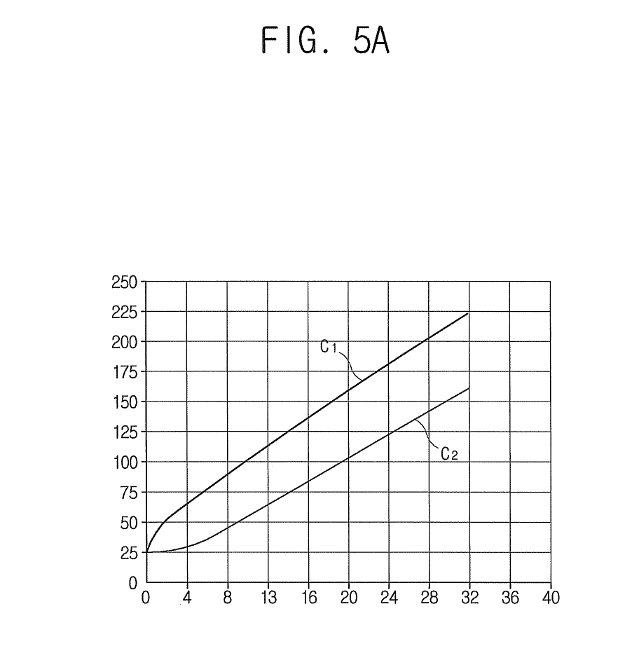

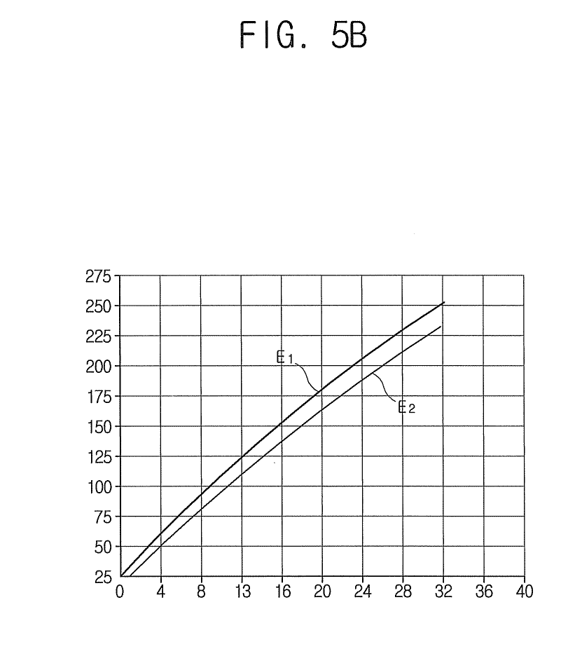

Hereinafter, a surface temperature change of the heating roller according to the present invention will be described by referring to FIGS. 5A and 5B.

FIGS. 5A and 5B are graphs illustrating a temperature change of the heating roller surface until 32 seconds have passed since 1,300-watt power was applied to the heat source in the fusing unit according to a comparative example and one of the exemplary embodiments of the present invention.

FIG. 5A illustrates a coil temperature C₁ and the heating roller surface temperature C₂ in the heating roller whose core is wound with the resistance heating unit as a heat source according to the comparative example. As shown in the graph, the coil temperature C₁ is 225° C. after 32 seconds have passed since the power was supplied to the coil, and the surface temperature C₂ of the heating roller is 160° C. Accordingly, the temperature difference ΔT between the coil and the heating roller surface is 65° C.

FIG. 5B illustrates the coil temperature E₁ and a surface temperature E₂ of the heating roller in which the embedded heating coil is filed in the depth of 0.7 mm from the surface of the rubber layer 23 according to the exemplary embodiment of the present invention. As shown in FIG. 5B, the coil temperature E₁ is 251° C. after 32 seconds have passed since the power was supplied to the coil, and the surface temperature E₂ of the heating roller is 233° C. Accordingly, the temperature difference ΔT between the temperatures of the coil and the surface of the heating roller is 18° C.

According to the result, since the temperature curves of the coil and the heating roller rise similarly, the temperature deviation between the temperatures of the coil and the heating roller is smaller than that in the comparative example even after the rising time has passed. Accordingly, although the coil temperature is maintained in a level similar to the comparative example, the surface temperature of the heating roller can be relatively raised.

In addition, in one of the exemplary embodiments of the present invention, the heat is prevented from being conducted into the core by inserting an insulating layer inside the embedded heating coil, thereby enhancing a temperature rising efficiency. Also, as a filing depth of the embedded heating coil lowers, a heat conductivity efficiency onto the surface improves, thereby enhancing a temperature rising efficiency.

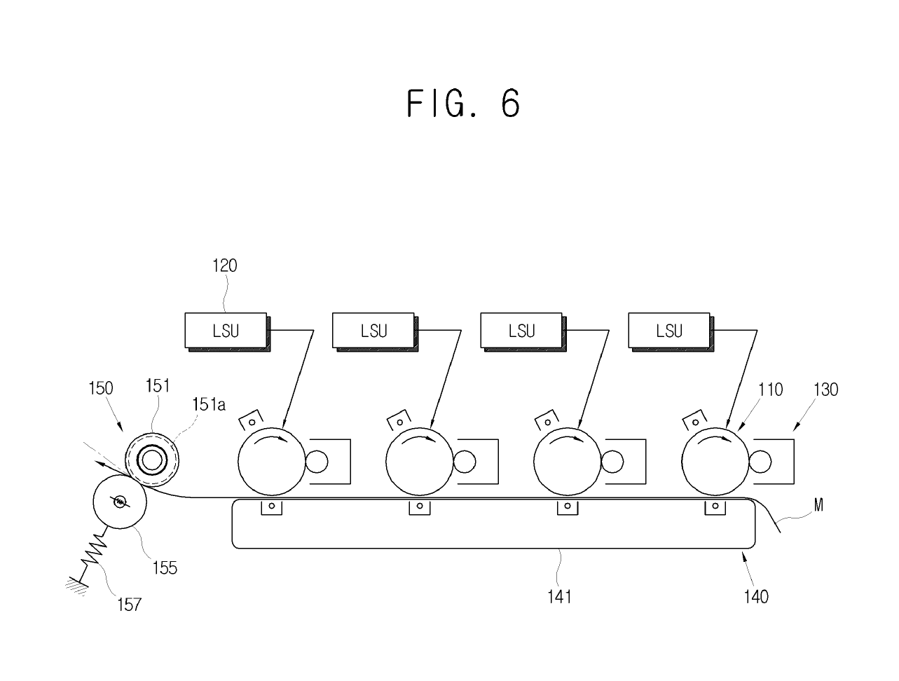

FIG. 6 is a schematic sectional view illustrating an image forming apparatus according to one of the exemplary embodiments of the present invention.

As shown in FIG. 6, the image forming apparatus includes photosensitive media 110, light scanning units (LSU) 120 which scan beam onto the photosensitive media 110 to form an electrostatic latent image thereon, developing units 130 which develop a toner image with respect to the electrostatic latent image formed on the photosensitive media 110, a transferring unit 140 which transfers the toner image formed in the developing units 130 onto the printing medium M, and a fusing unit 150 which fuses the transferred non-fused toner image onto the printing medium M.

FIG. 6 denotes a tandem-type color image forming apparatus as an example, and the photosensitive media 110, the light scanning unit 120 and the developing unit 130 are provided along a conveying route of the printing medium M according to respective colors.

The transferring unit 140 is disposed to face the plurality of photosensitive media 110 across the printing medium M transferred through the conveying route. The transferring unit 140 transfers the toner image formed in the photosensitive media 110 to the supplied printing medium M. For this purpose, the transferring unit 140 includes a transferring belt 141 which is disposed to face the plurality of photosensitive media 110.

The fusing unit 150 includes a heating roller 151 which has an embedded heating coil 151 a, a pressing roller 155 which presses the printing medium M on which the non-fused toner image is formed with the heating roller 151, and an elastic member 157 which elastically biases the pressing roller 155 toward the heating roller 151. Accordingly, the heating roller 151 is heated on its surface by the heat generated in the embedded heating coil 151 a, and fuses the non-fused toner image transferred on the printing medium M by pressing against the pressing roller 155. Here, the description of a configuration and an operation principle of the fusing=unit 150 will be omitted as they are the same as those of the fusing unit according to the above-described exemplary embodiment of the present invention.

As described above, in the fusing unit and the image forming apparatus using the fusing unit according to an embodiment of the present invention, the heat generated in the embedded heating coil can be transferred onto the surface of the heating roller without a separate vehicle by embedding the heating coil inside of the rubber layer of the heating roller.

Also, since the embedded heating coil is positioned closely to a surface of the heating roller, heat can be easily conducted onto the surface, and a heat source is further provided inside the pressing roller, thereby supplying heat for both sides of a printing medium. Accordingly, since a temperature rising time can be reduced and a surface temperature can be maintained at a high level, the fusing efficiency can be maintained by increasing the heat flux even if the width of the fusing nip is small or the fusing time is reduced due to a conveying speed increase of the printing medium.

In addition, if a surface temperature of the heating roller is set as in a conventional fusing unit, temperature of the embedded heating coil can be lowered, thereby decreasing the problem of a thermal expansion and contraction caused by excessive heat.

Furthermore, a fusing nip is formed by bending of a rubber layer which forms a heating roller in the formation of the fusing nip, and a wrap jam and a curl can be reduced by further providing a heat source inside a pressing roller.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A fusing unit on a printing path of an image forming apparatus, and which fuses an image onto a printing medium, the fusing unit comprising:
a heating roller having a core member, a rubber layer which is formed to have a predetermined thickness on an outer circumference of the core member, a release layer which is formed on the outer surface of the rubber layer and prevents the printing medium from being adhered to the heating roller, and a heating coil which generates heat and is embedded inside the rubber layer and applies the generated heat to the rubber layer;
a pressing roller which is disposed to face the heating roller, and presses the printing medium in collaboration with the heating roller; and
an elastic member which elastically biases the pressing roller toward the heating roller and forms a fusing nip to have a predetermined width between the heating roller and the pressing roller.

2. The fusing unit according to claim 1, wherein the heating coil is embedded as deep as 0.2 mm to 0.7 mm from an outer surface of the rubber layer.

3. The fusing unit according to claim 2, wherein the rubber layer is provided to have at least 5 mm thickness.

4. The fusing unit according to claim 1, further comprising an insulating layer which is positioned between the core member and the rubber layer, or is embedded inside the rubber layer, and blocks the heat generated in the heating coil from being transferred to the core member.

5. The fusing unit according to claim 4, wherein an elasticity of the rubber layer is greater than an elasticity of the pressing roller so as to form the fusing nip by bending of the rubber layer.

6. The fusing unit according to claim 5, further comprising a heat source which is built in the pressing roller, and applies heat to the pressing roller.

7. The fusing unit according to claim 1, wherein an elasticity of the rubber layer is greater than an elasticity of the pressing roller so as to form the fusing nip by bending of the rubber layer.

8. The fusing unit according to claim 7, further comprising a heat source which is built in the pressing roller, and applies heat to the pressing roller.

9. The fusing unit according to claim 1, wherein the heating roller is rotated depending on rotation of the pressing roller.

10. The fusing unit according to claim 1, further comprising a heat source which is built in the pressing roller, and applies heat to the pressing roller.

11. The fusing unit according to claim 1, wherein the pressing roller further comprises a metal core and a thin coating layer formed on an outer circumference of the metal core, wherein an elasticity of the thin coating layer is less than an elasticity of the rubber layer of the heating roller.

12. The fusing unit according to claim 1, wherein the pressing roller further comprises a metal core, a first insulating layer formed on the outer circumference of the core, a resistance heating unit formed on the outer circumference of the first insulating layer, a second insulating layer formed on the outer circumference of the resistance heating unit, and an elastic layer formed on the outer circumference of the second insulating layer.

13. An image forming apparatus, comprising:
a photosensitive medium;
a light scanning unit which scans beams onto the
photosensitive medium and forms an electrostatic latent image;
a transferring unit which transfers a toner image formed in the developing unit onto a printing medium; and
a fusing unit which fuses a non-fused toner image onto the printing medium the fusing unit comprising:
a heating roller having a core member, a rubber layer which is formed to have a predetermined thickness on an outer circumference of the core member, a release layer which is formed on the outer surface of the rubber layer and prevents the printing medium from being adhered to the heating roller, and a heating coil which generates heat and is embedded inside the rubber layer and applies the generated heat to the rubber layer;
a pressing roller which is disposed to face the heating roller, and presses the printing medium in collaboration with the heating roller; and
an elastic member which elastically biases the pressing roller toward the heating roller and forms a fusing nip to have a predetermined width between the heating roller and the pressing roller.

14. The image forming apparatus according to claim 13, wherein the fusing unit further comprises an insulating layer which is positioned between the core member and the rubber layer or is embedded inside the rubber layer, and blocks heat generated in the heating coil from being transferred toward the core member.

15. The image forming apparatus according to claim 14, wherein an elasticity of the rubber layer is greater than an elasticity of the pressing roller so as to form the fusing nip by bending of the rubber layer.

16. The image forming apparatus according to claim 15, further comprising a heat source which is built in the pressing roller and applies heat to the pressing roller.

17. The image forming apparatus according to claim 13, wherein an elasticity of the rubber layer is greater than an elasticity of the pressing roller so as to form the fusing nip by bending of the rubber layer.

18. The image forming apparatus according to claim 17, further comprising a heat source which is built in the pressing roller and applies heat to the pressing roller.

19. The image forming apparatus according to claim 13, wherein the heating roller is rotated depending on rotation of the pressing roller.

20. The image forming apparatus according to claim 13, further comprising a heat source which is built in the pressing roller and applies heat to the pressing roller.
